(19) United States
(12) Patent Application Publication
(10) Pub. No.: US 2009/0074519 A1
(43) Pub. Date: Mar. 19, 2009

(54) MILLING CUTTER

(75) Inventor: HAI-BO YU, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/125,072

(22) Filed: May 22, 2008

(30) Foreign Application Priority Data
Sep. 14, 2007 (CN) 200710201707.9

(51) Int. Cl. B26D 1/12

(52) U.S. Cl. 407/34

(57) ABSTRACT

A milling cutter includes a cutting portion including a depression portion and a sidewall surrounding the depression portion, wherein an exterior surface of the side wall is a cylindrical surface, at least a part of an internal surface of the side wall is a slanted surface, so as to form at least one tooth.

### BACKGROUND

1. Field of the Invention

The present invention generally relates to cutting tools, and more particularly, to a milling cutter.

2. Description of Related Art

A conventional milling cutter is usually used for milling a workpiece to obtain a hole therein. Generally, the milling cutter includes a shank, a cutting portion, and a neck connecting the cutting portion to the shank. The shank, the cutting portion, and the neck have a same rotational axis. The shank is configured for being clamped, by a tool holder. The cutting portion includes a cylindrical main body and two teeth helically disposed around an outer surface of the main body, thus, deep helical grooves known as flutes are defined between the teeth on the outer surface of the main body. There is almost one tooth per flute. The flutes are used for allowing chips cut by the teeth to travel out of the milling cutter.

In operation, the milling cutter is used for milling a workpiece to form a hole. Firstly, the rotational axis of the milling cutter is aligned with a predetermined coordinate where the hole is to be defined in the workpiece. After that, the milling cutter is pressed and then rotated. Subsequently, the milling cutter drills straight down through the workpiece, with the teeth cutting the workpiece and chips of the workpiece flowing in the flutes and then cleared out of the flutes by the rotation of the milling cutter, therefore, the hole is formed on the workpiece.

However, when the teeth are cutting the workpiece, the chips may not be removed from the flutes as fast as they are produced, thus, more and more chips are retained in the flutes. When the flutes are filled up with the chips, some chips will stay between the milling cutter and the workpiece, thus frictions between the chips and the workpiece will greatly increase, and therefore, causing overheating.

Therefore, a new and improved milling cutteris desired to overcome the above-described shortcomings.

### SUMMARY

A milling cutter includes a cutting portion including a depression portion and a sidewall surrounding the depression portion, wherein an exterior surface of the side wall is a cylindrical surface, at least a part of an internal surface of the side wall is a slanted surface, so as to form at least one tooth.

Other systems, methods, features, and advantages of the present milling will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present milling cutter can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is an isometric view of a milling cutter in accordance with a first exemplary embodiment;

FIG. 2 is an enlarged view of a circled portion II which is a part of the milling cutter of FIG. 1;

FIG. 3 is a cross-sectional view of the milling cutter taken along the line III-III of FIG. 2;

FIG. 4 is an isometric view of a second typical milling cutter; and

FIG. 5 is a cross-sectional view of the milling cutter taken along the line V-V of FIG. 4.

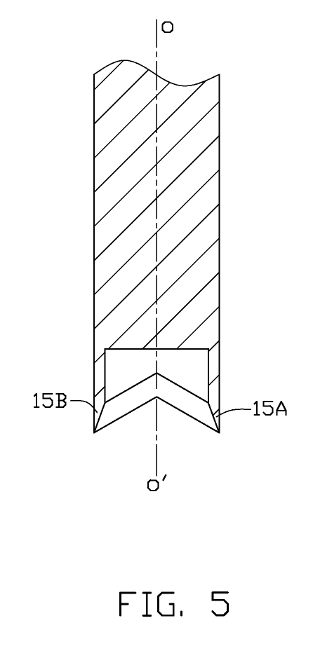

### DETAILED DESCRIPTION

Reference will now be made to the drawings to describe the preferred embodiments of the present milling cutter, in detail.

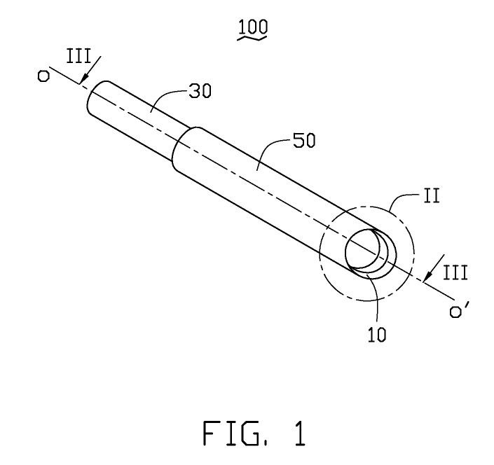

Referring to FIG. 1, a milling cutter 100, in accordance with a first exemplary embodiment, having one tooth, includes a cutting portion 10, a shank 30, and a neck 50 connecting the cutting portion 10 to the shank 30. The cutting portion 10, the shank 30, and the neck 50 have a same rotational axis OO′. The shank 30 is configured for being clamped, by a tool holder (not shown). Both the shank 30 and the neck 50 are cylindrical, but a diameter of the shank 30 is less than that of the neck 50.

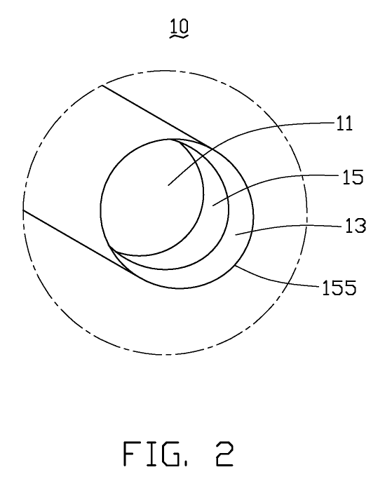

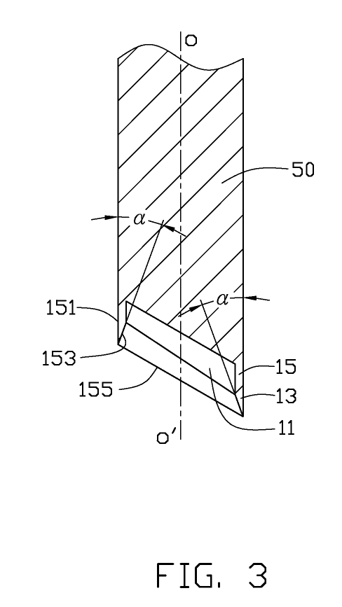

Referring to FIGS. 2-3, the cutting portion 10 is disposed at a distal end of the neck 50 away from the shank 30. The cutting portion 10 is a cylinder with a free end aslant cut off by a virtual plane to form a slanted elliptical cutting edge 155. A depression portion 11 is defined in the free end of the cutting portion 10 along the rotational axis OO′. The cutting portion 10 includes an annular sidewall 15 surrounding the depression portion 11. An exterior surface 151 of the side wall 15 is a smooth regular cylindrical surface. An end of an internal surface 153 of the sidewall 15 adjacent to the cutting edge 155 is a slanted surface, so as to form a sharp tooth 13 at the free end of the cutting portion 10. The cutting edge 155 is the tip of the tooth 13. A tooth angle α is defined between the exterior surface 151 and the end of the internal surface 153. The prior range of the tool angle α is between 10 degrees and 30 degrees. A preferred tool angle is predetermined according to rigidity and thickness of the workpiece. In the typical embodiment, the workpiece is made of plastic, and the tool angle α is 20 degrees.

In operation, the milling cutter 100 is used for milling the workpiece, thereby, forming a hole in the workpiece. Firstly, the rotational axis OO′ of the milling cutter 100 is aligned with a predetermined coordinate where the hole is to be defined. After that, the milling cutter 100 is pressed and then rotated. Subsequently, the milling cutter 100 drills straight down though the workpiece, meanwhile the tooth 15 cuts the workpiece, and chips of the workpiece are deposited in the depression portion 11, forming the hole in the workpiece.

The above milling cutter 100 includes the depression portion 111 which can provide a comparative large space for receiving the chip of the workpiece cut by the milling cutter 100, and the depression portion 111 is enclosed by the sidewall 15 which a tooth is formed on, therefore, the chips of the workpiece cut by the milling cutter can be cleared from the workpiece as soon as they are produced, therefore, friction between the chips and the workpiece is not created, and a temperature between the milling cutter 100 and the workpiece is not affected by the chips.

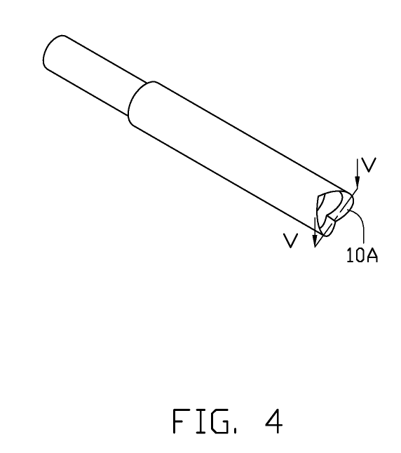

Referring to FIG. 4, 5, a milling cutter 100A in accordance with a second exemplary embodiment has two teeth. In comparison with the first embodiment, a cutting portion 10A includes a first tooth 15A and a second tooth 15B symmetrical with the first tooth 15A corresponding to a virtual plane which a rotational axis OO′ of the cutting body 100A is in. The cutting portion 10A is a cylinder with a free end cut off by two virtual surfaces whose sectional view is an inverse V-shaped to form the first tooth 15A and a second tooth 15B at the free end.

When the milling cutter 100A is used for milling a workpiece to obtain a hole, the chips of the workpiece can be removed from the workpiece as fast as they are produced also, therefore, temperature between the milling cutter 100 and the workpiece is maintained.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A milling cutter comprising:
a cutting portion comprising:
a depression portion; and
a sidewall surrounding the depression portion;
wherein an exterior surface of the side wall is a cylindrical surface, at least a part of an internal surface of the side wall is a slanted surface, so as to form at least one tooth.

2. The milling cutter as claimed in claim 1, wherein the cutting portion is a cylinder with a free end aslant cut off by a virtual plane to form a slanted and elliptical cutting edge, and the depression portion is defined in the free end.

3. The milling cutter as claimed in claim 1, wherein a tooth angle is defined between the exterior surface and the internal surface, the tool angle is between 10 degrees and 30 degrees.

4. The milling cutter as claimed in claim 3, wherein the tool angle is 20 degree.

5. The milling cutter as claimed in claim 1, further comprising a shank for holding and locating the milling cutter and a neck for connecting the cutting portion to the shank.

6. The milling cutter as claimed in claim 1, wherein the cutting portion is a cylinder with a free end cut off by two virtual surface whose sectional view is V-shaped to form two tooth symmetrical with each other, and the depression portion is defined in the free end.
